(19) United States
(12) Patent Application Publication
(10) Pub. No.: US 2004/0244031 A1
(43) Pub. Date: Dec. 2, 2004

(54) System and method for a network of interactive televisions

(76) Inventor: Peter Martinez, San Pedro, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/789,032

(22) Filed: Feb. 26, 2004

Related U.S. Application Data
(60) Provisional application No. 60/450,544, filed on Feb. 26, 2003.

(51) Int. Cl. H04N 7/173; H04N 7/16; G06F 17/00

(52) U.S. Cl. 725/25; 725/28; 725/89; 725/134; 725/142

(57) ABSTRACT

Aspects of embodiments of at least one of the inventions disclosed herein include a system and method for delivering content within a network of interactive televisions. In accordance with one embodiment of at least one of the inventions disclosed herein, the system distributes media content, such as video and music, across a communications network comprising at least one server and at least one client device. Users of the system utilize a client device to access the media content, to view a preview or a description of the media content, and to purchase the media content. The client device receives the media content from the server, and the client device stores the media content within a storage device on the client device. The client device employs interface devices to facilitate user interaction with the system. The server records the purchase of media content and other activities and preferences of the user of the client device.

### PRIORITY INFORMATION

The present application is based on and claims the benefit of U.S. Provisional Application No. 60/450,544, filed on Feb. 26, 2003, under 35 U.S.C. § 119(e), the entire contents of which is hereby expressly incorporated by reference.

### BACKGROUND OF THE INVENTIONS

1. Field of the Inventions

The inventions disclosed herein relate to a system and method for content delivery, and more specifically, to a system and method for delivering content within a network of interactive client devices.

2. Description of the Related Art

Currently, many hotels provide in-room entertainment to their guests through televisions and set-top boxes. In-room entertainment usually includes movies, broadcast or cable television channels, informational programming, and the like. Hotels generally charge a fee for some or all in-room entertainment.

However, current in-room entertainment systems have several disadvantages. At least one in-room entertainment system provides movies through a split cable network: For example, such a system can include one or a plurality of video players continuously playing all of the movies available for purchase. The video players output analog video signals over cables that are connected to switches that split and selectively distribute the video output only to the guests that have paid for the video content. Such systems result in poor quality video images. Such systems are also dependent on central storage and distribution hardware, thus cannot deliver the content if there is a malfunction at the central storage location.

### SUMMARY OF THE INVENTIONS

The inventions disclosed herein relate to a system and method for content delivery, and more specifically, to a system and method for delivering content within a network of interactive content players, which can comprise a television, video monitor, and/or audio player.

One embodiment of at least one of the inventions disclosed herein includes a method for distributing media content across a communications network comprising at least one server and at least one client device, the client device having at least one storage device, the method comprising sending a plurality of media files from the server to the client device, sending a command from the server to the client device, the command directing the client device to store the plurality of media files in the storage device, allowing a user to browse through descriptions of the media files in the storage device, preventing the user from accessing the entirety of the media files in the storage device, communicating with the server to authorize the user to access at least one media file in the storage device, and allowing the user to access the at least one media file if the user is authorized to access the media file.

In some arrangements, this embodiment only allows the user to access the media file if the user has agreed to pay for access to the media file, for example, but without limitation, by allowing a monetary charge to be associated with the user's account.

Another embodiment of at least one of the inventions disclosed herein is a method for selling media content to users of a client device which has a storage device and is connectable to a network. The method comprises storing a plurality of media files in the storage device of the client device, allowing the user to browse descriptions of the media files stored in the storage device, preventing the user from accessing the entirety of the media files, and allowing a user to authorize payment for access to at least one of the media files.

Another embodiment of at least one of the inventions disclosed herein is a method of tracking fees to guests of a hotel having at least one client device in each of a plurality of guestrooms in a hotel. The client device comprises a video display and computer connected to a server. The method comprises storing a plurality of full-length major motion pictures on a storage device of the client device, allowing a user to browse descriptions of the full-length major motion pictures, preventing the user from fully accessing the full-length major motion pictures, requesting confirmation for authorization for the user to access at least one of the full-length major motion pictures, allowing the user to fully access the at least one full-length major motion picture only if authorization is confirmed.

Another embodiment of at least one of the inventions disclosed herein is a communications network for distributing media content comprising at least one server, and at least one client device having a storage device therein, the client device configured to receive media files from the server and to store the media files from the server on the storage device without the need for any user inputs to the client device, the client device being configured to allow a user of the client device to access the media files only if the user is authorized to access the media files.

Another embodiment of at least one of the inventions disclosed herein is a communications network for distributing media content comprising at least one server configured to distribute media content over the network, at least one client device communicating with the server over the network, and means for storing media content from the server on a storage device of the client device without the need for any user inputs to the client device, means for deleting and adding media content to the storage device of the client device from the server, without the need for any user inputs to client device, and means for selectively allowing a user to access the media content based on a payment protocol.

Another embodiment of at least one of the inventions disclosed herein is a workstation comprising a video display, a processor, memory, and computer readable media stored in the memory and configured to allow the workstation to accept a plurality of media files from a server over a network, to store the plurality of media files in the memory without the need for any user inputs to the workstation, and to selectively allow a user to access the media files if the user has authorization.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

The present invention is described in more detail below in connection with the attached drawings, which are meant to illustrate and not to limit the invention, and in which:

FIG. 1 illustrates a block diagram of a content delivery system, according to an embodiment;

FIG. 2 illustrates a block diagram of a user system, according to an embodiment;

FIG. 3 illustrates a block diagram of a presentation management system, according an embodiment;

FIG. 4 illustrates a block diagram of a content source system, according to an embodiment;

FIG. 5 illustrates a block diagram of a content delivery system, illustrating a sample infrastructure of the content delivery system, according to an embodiment; and

FIG. 6 illustrates a block diagram of a user interface screen hierarchy, according to an embodiment.

### DETAILED DESCRIPTION OF THE PREFERRED EMBODIMENT

The features of the systems and methods will now be described with reference to the drawings summarized above. Throughout the drawings, reference numbers are re-used to indicate correspondence between prior-referenced elements. In addition, the first digit of each reference number indicates the figure in which the element first appears. The drawings, associated descriptions, and specific implementation are provided to illustrate embodiments of the invention, and not to limit the scope of the invention. The scope of the invention is defined by the appended claims.

### I. Overview

Certain of the inventions disclosed herein relate to a system and method for content delivery, and more specifically, to a system and method for delivering content within a network of interactive televisions. Generally, “content” or “media content” refers to various forms of communication and data that convey information to a user, and can include a variety of data formats, such as, for example, video, voice, image, Flash media, audio, visual, and so forth. Media content can convey any information or message, such as news, weather reports, movies, television programs, music, and the like. Media content can also contain marketing, advertising, and consumer relations messages. Media content can also comprise short films, broadcasts, and other types of presentation or entertainment. The media content can be of any nature including, but without limitation, electronic, analog, digital, or part analog and part digital. The media content can take any form or configuration.

Generally, the term “user” refers to a person, such as a hotel guest, using a user system, a set-top box, an interactive television, and the like. Generally, the term “user system” refers to a device used by a user, network user, or hotel guest such as a set-top box or a client device in a client/server system.

Moreover, it is to be understood that although the inventions are disclosed with reference to a hotel or casino, the inventions can be implemented within any building, facility, combination of facilities, or any geographical area.

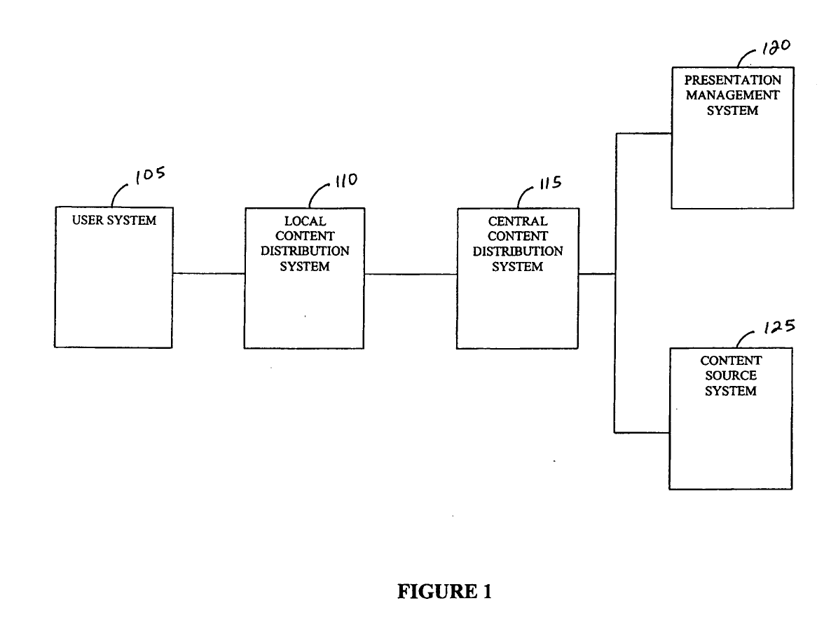

FIG. 1 illustrates a block diagram of a content delivery system, according to aspects of an embodiment of at least one of the inventions disclosed herein. As illustrated, the content delivery system can comprise a user system 105, a local content distribution system 110, a central content distribution system 115, a presentation management system 120, and a content source system 125. The above-noted systems have been identified as individual systems for ease of description. However, it is conceived that, in some embodiments, the a local content distribution system 110, a central content distribution system 115, a presentation management system 120, and a content source system 125 can be part of a single system, such as computer.

In this embodiment, the user system 105 communicates with the local content distribution system 110. The local content distribution system 110 communicates with the user system 105 and the central content distribution system 115. The central content distribution system 115 communicates with the local content distribution system 110, the presentation management system 120, and the content source management 125. The presentation management system 120 communicates with the central content distribution system 115. The content source system 125 communicates with the central content distribution system 115.

It is to be understood that FIG. 1 illustrates a logical diagram of the content delivery system and various embodiments and variations can be utilized. In one embodiment, the local content distribution system 110 and the central content distribution system 115 can be contained in one system or distributed amongst several systems. In another embodiment, the presentation management system 120 and the content source system 125 can be implemented as one system or as several systems. Moreover, other embodiments can utilize other topologies to implement the content delivery system illustrated in FIG. 1.

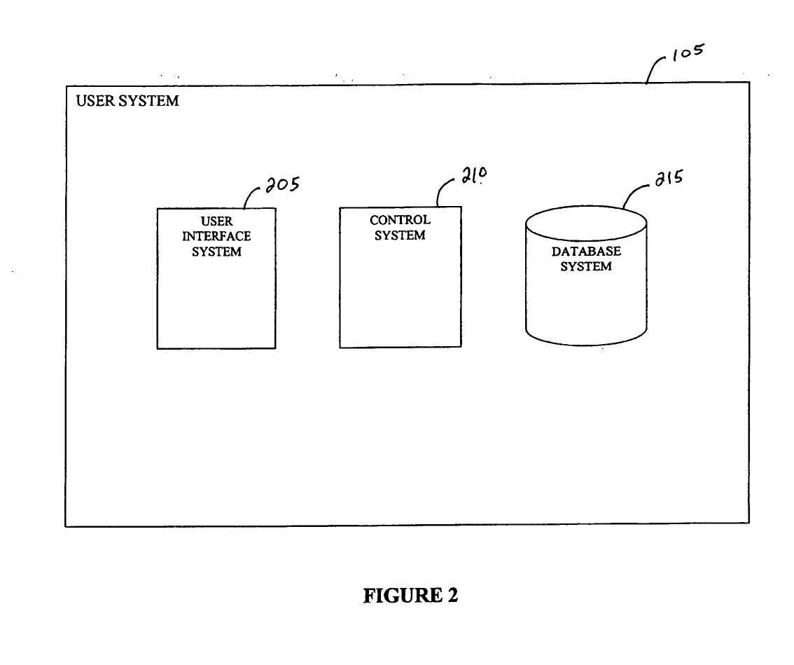

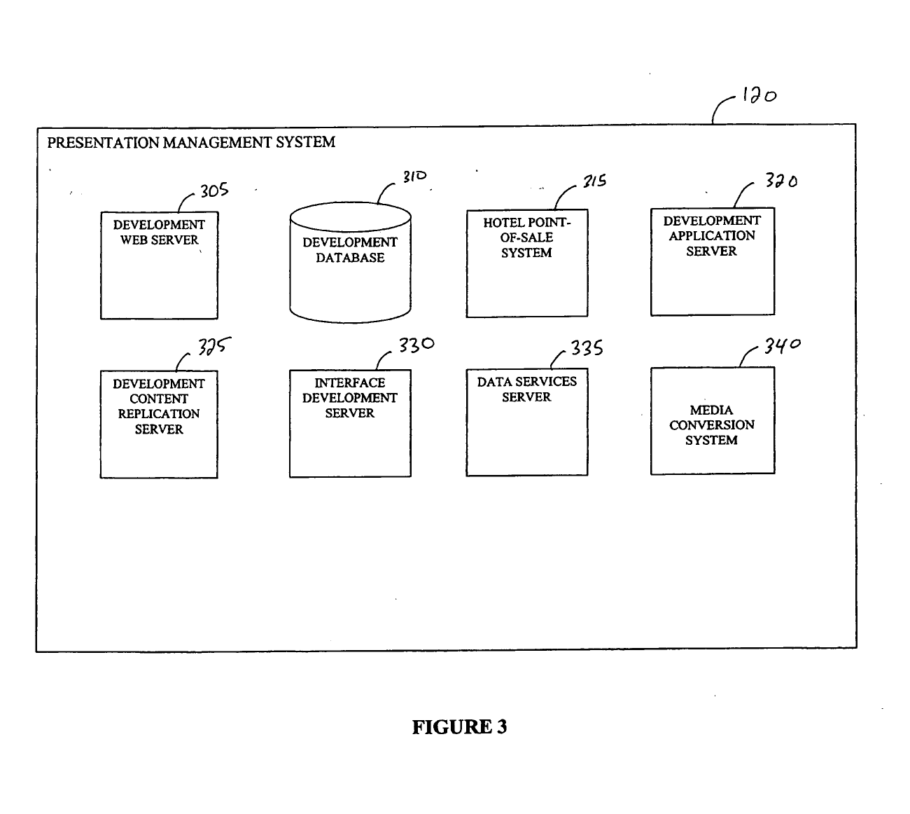

The user system 105 is further described with reference to FIG. 2. The presentation management system 120 is further described with reference to FIG. 3. Generally, the presentation management system 120 comprises modules, and their supporting devices, that are utilized in presenting content to a user. Generally, the content source system 120 comprises modules, and their supporting devices, associated with the content presented to a user.

### II. User System

FIG. 2 illustrates a block diagram of the user system 105, according to at least one of the embodiments disclosed herein. As illustrated in FIG. 2, the user system 105 comprises a user interface system 205, a control system 210, and a database system 215.

In one embodiment, the user interface system 205 comprises a computer user interface system, device, or software. Generally, a computer user interface comprises a computer program that allows the user to interact with a computer system and provides a visual and/or audio presentation to the user. A computer user interface can be custom-made or tailored for a particular application or it can be a part of a commercially available system. In one embodiment, the user interface system 205 includes a video display device such as a television, a computer monitor, and the like. In one embodiment, the user system 205 operates similar to a client device within a client/server environment.

In one embodiment, the control system 210 enables the user 105 to communicate with the content delivery system. The control system 210 can be a general purpose computer, or portions thereof, using one or more microprocessors, such as, for example, a Pentium® processor, a Pentium II® processor, a Pentium Pro® processor, a Pentium IV® processor, an x86 processor, an 8051 processor, a MIPS processor, a Power PC® processor, a SPARC® processor, an Alpha processor, and so forth.

In one embodiment, the processor unit operates the Linux® operating system and performs standard operating system functions. It is recognized that other operating systems can be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Palm Pilot OS, Apple® MacOS®, Disk Operating System (DOS), UNIX, IRIX, Solaris, SunOS, FreeBSD, Microsoft® Windows® XP, IBM® OS/2® operating systems, custom-made operating systems, and so forth.

In one embodiment, the control system 210 and the user interface system 205 operate together to present various aspects of the content delivery system to the user. In one embodiment, the content delivery system can request payment from the user for access to at least one of the media files stored in the user system. In one embodiment, the control system 210 is-configured to delete at least one of the media files stored in the user system without the need for any user input into the user system. In one embodiment, the control system 210 is configured to store a plurality of files in the user system upon receiving a command but without the need for any user inputs. In one embodiment, the control system 210 and the user interface system 205 are configured to allow the user to browse the descriptions of the content available on the user system.

In one embodiment, the user system 105 is equipped with conventional network connectivity, such as, for example, Ethernet (IEEE 802.3), wireless Ethernet 802.11a and 802.11b, Token Ring (IEEE 802.5), Fiber Distributed Datalink Interface (FDDI), or Asynchronous Transfer Mode (ATM). Further, the client system 120 can be configured to support a variety of network protocols such as, for example NFS v2/v3 over UDP/TCP, Microsoft® CIFS, HTTP 1.0, HTTP 1.1, DAFS, FTP, RTSP, and so forth.

In one embodiment, the database system 215 comprises a computer database system, program, software, or device and includes at least one storage device or system. Such storage devices can include any type of commercially available or custom built storage device capable of storing digital media content, such as, for example, but without limitation, one, a plurality, and/or any combination of random access memory (RAM) devices, flash memory devices, magnetic storage devices such as tape drives, floppy disks, hard disks, and optical storage devices such as writable and re-writable compact discs and DVDs®, and so forth. As used herein, the term “storage device” is used to mean one, a plurality, or any combination of the above-noted storage devices. Such a storage device can also be used to store any other software used on the user system 105, including, for example, but without limitation, the operating system used therein.

The database system 215 can maintain information about the user, media content, and other information. For example, the database system 215 can comprise of movie files, music files, video files having a normal playtime of at least 30 minutes, full-length major motion pictures, data files, and other content. The database system 215 can comprise a secured library of media files and other content. In one embodiment, the content stored in the database system 215 is encrypted using a variety of encryption systems and algorithms, as is well known in the art.

It should be understood that the database system 215 can be implemented using any combination of types of hardware and different databases types such as relational databases, flat file databases, object-oriented databases, and the like. Moreover, while the database system 215 depicted in FIG. 2 is illustrated as one database, it is recognized that in other embodiments, the database system 215 can be implemented as multiple databases and/or the database system 215 can include other databases. In addition, the database system 215 can be implemented as other data structures that are well know in the art, such as linked lists, stacks, binary trees, and so forth.

In one embodiment, the user system 105 can comprise various interface devices. For example, the user system 105 can comprise a RFID (Radio Frequency Identifier Device) reader. In one embodiment, the user system 105 can comprise a remote control device, used by a user of the user system 105 to interact with the user system 105. For example, but without limitation, the such a remote control can be configured to allow a user to move a cursor in at least two directions, but more preferably four directions; left, right, up and down, the device having one button for each direction. As such, a user can highlight active fields generated on the associated display with the cursor and select a highlighted field with another button on the device, such as the technique commonly used in conjunction with remote controls used with commercially available DVD® players. In one embodiment, the user system 105 can comprise an infrared input device, used by a user of the user system 105 to directly interact with the user system 105. In some embodiments, the input device is a conventional keyboard. In some embodiments using a keyboard as a user input device, certain keys of the keyboard can be disabled so as to aid in security. For example, the backslash, forward slash and/or period keys can be disabled to make it more difficult for a user to gain unauthorized access (“hacking”) into a network communicating with the user system 105. For example, such keys of a key board can be permanently modified so as to prevent use of such keys. In one example, a key can be removed by pulling and then a hole can be drilled through the physical switch lying beneath the key. Optionally, an insulator, such as a strong glue, can be used to permanently disable the switch associated with the disabled key. Other methods for key disablement, and other keys can also be disabled. Additionally, other security measures can also be used alone or in combination with the above-noted key disablement.

A. User Interface Screens

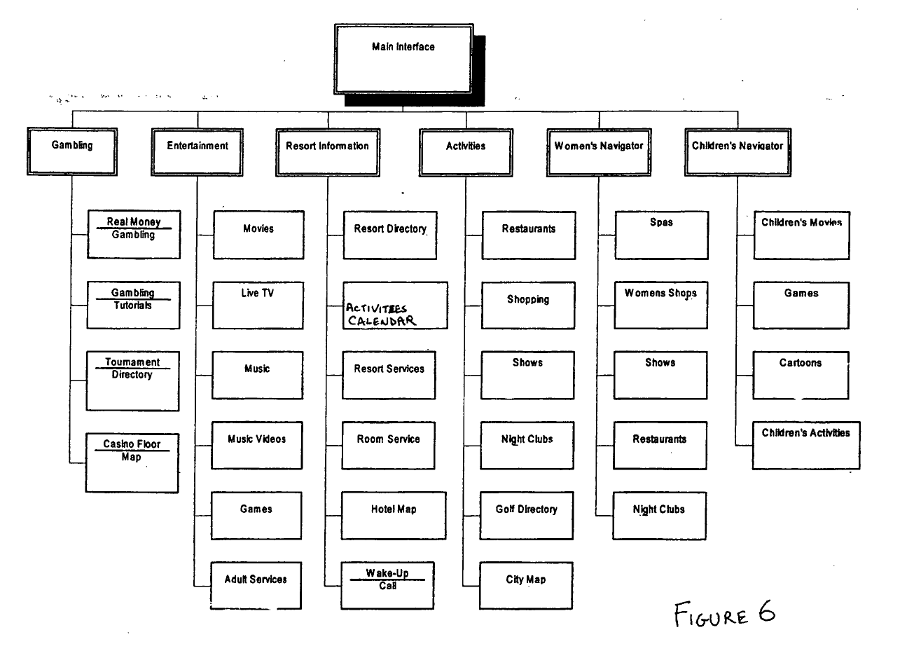

FIG. 6 illustrates a block diagram of a user interface screen hierarchy, according to aspects of an embodiment of at least one of the inventions disclosed herein. As illustrated, a tree of user interface screens allow a user to navigate through the user services available in the content delivery system. In some embodiments, where the user input device is a DVD®-type remote control unit, the user can highlight optional menus shown in the display, the use a selection button to enter the sub-menu associated with the selected menu.

For example, as shown in FIG. 6, an initial, or “main interface” screen, can include fields, which can be in the form of text or graphics, representing categories. As an example, the initial screen can include fields including text and/or graphics representing categories, such as but without limitation, resort information, entertainment, activities, gambling, women-related activities, and children-related activities.

After selecting a category, a submenu will appear on the display, offering the user a submenu of further choices. For example, selecting the resort information category can trigger a sub menu to appear offering choices such as a resort directory, activities calendar, resort services, room service, hotel map, and wake-up call. Similarly, selecting the entertainment category can open a sub menu including videos, live TV, music, music videos, games, and adult services. Selecting the activities category can open a submenu offering restaurants, shopping, shows, night clubs, golf directory, and city map.

Certain of the categories can be protected. For example, the Casino category can be password protected to prevent children or others from accessing content therein. As such, selecting the Casino category can open a screen requiring the user to enter an access code to enter the casino features of the content delivery system.

Selecting the category of women-related activities can open a sub menu including spas, shopping, beauty salons, restaurants, shows, and night clubs. In some embodiment, selecting the children-related activities can open a sub menu offering children's movies, games, cartoons, and other children's activities.

Further descriptions of possible options are set forth below to illustrate possible choices that can be provided to a user of the user system 105. However, it is to be understood that the options described below are intended to merely illustrate optional configurations and content of the user system, but not to limit such.

For example, the resort services sub menu can offer automated check-out, bell services, valet services, maid services, and taxi services. The room service sub menu, can be configured to allow a user to order room service.

The hotel map sub menu can be configured to allow a user to view maps of the hotel or casino, and change between levels of the hotel or casino. The wake-up call sub menu can be configured to allow a user to set and activate a wake-up call.

A video category, sub menu can be configured to allow a user to select pay-per-view, independent movies, mini-series, and family movies. Any of the screens can include a confirmation screen that enables a user to avoid inadvertently selecting a service or product that the user did not intend to purchase.

In some embodiments, a video category sub menu can be configured to allow a user to preview content prior to purchase. The preview can comprise of a variety of information such as a short movie clip, a description, a movie poster, and the like.

A restaurant sub-menu sub menu can be configured to allow a user to browse through a list of restaurants. The shopping directory sub-menu sub menu can be configured to allow a user to browse through a list of stores. Similarly, the night club sub-menu sub menu can be configured to allow a user to browse through a list of night clubs.

A golf course directory sub-menu can be configured to allow a user to browse through a list of golf courses. A city map sub menu can be configured to allow a user to browse through a city map This module can be configured to allow a user to focus on a particular area of interest to the user.

An initial gambling-related sub menu can give the user the option of accessing gambling tutorials or accessing the casino. Similarly, a music sub menu can be configured to allow a user to purchase music service packages. Such music packages can include music categories choices, including, for example, but without limitation, R & B, rap, oldies, classical, rock, and hip hop. Optionally, the music packages can allow a user to choose packages of access, for example, but without limitation, an “all access pass” allowing a user to access all music on the user system 105, as well as other packages offering more limited access.

The user system 105 can also be configured to allow a user to search for content such as music, music videos, movies, or any other content stored on the user system 105, or otherwise accessible through the user system 105 by user-initiated download or otherwise.

### III. Local Content Distribution System

FIG. 1 illustrates the local content distribution system 110. The local content distribution system 110 communicates media content and data from the central content distribution system 115 to the user system 105. The local content distribution system 110 communicates data from the user system 105 to the central content distribution system 115. In one embodiment, the local content distribution system 110 comprises a computer system, network or device configured to distribute media content and data to within a local distribution area. The local distribution area can be a hotel floor, a portion of a hotel, or an entire hotel, in the illustrated embodiment.

In one embodiment, the local content distribution system 110 can comprise a computer network or a switch. For example, the local content distribution system 110 can comprise a switch configured for 24 port Ethernet at 100 Mb/s (Millions of Bytes per second). The local content distribution system 110 can also be configured to distribute media content or data to various zones within a hotel floor. A zone can be a range or set of hotel rooms or an entire hotel floor. Each zone can comprise an access point to receive the media content or data from the local content distribution system 110. In one example, the access point can utilize the 802.11a, b, or g communication protocol. In one embodiment, the access point in each zone communicates media data and content to the user system 105 using wireless communication. For example the access point can transfer media content and data to the user system 105 using a wireless up-link, such as a wireless up-link operating at 5 Mb/s.

### IV. Central Content Distribution System

FIG. 1 illustrates the central content distribution system 115. The central content distribution system 115 communicates media content and data from the presentation management system 120 and the content source system 125 to the local content distribution system 110. The central content distribution system 115 communicates data from the local content distribution system 110 to the presentation management system 120 and the content source system 125. In one embodiment, the central content distribution system 115 comprises a computer system, network, or device configured to distribute media content and data to within a distribution area. The distribution area can be an entire hotel, or a portion of a hotel.

In one embodiment, the central content distribution system 115 can comprise a computer network or a switch. For example, the central content distribution system 115 can comprise an Ethernet switch with 64 Gigabit Ethernet ports. The central content distribution system 115 can also be configured to communicate the Internet through a Gigabit Ethernet connection and a firewall, as is well known in the art.

### V. Presentation Management System

FIG. 3 illustrates a block diagram of the presentation management system 120, according to aspects of an embodiment of at least one of the inventions disclosed herein. As illustrated, the presentation management system 120 comprises a development web server 305, a development database 310, a hotel point-of-sale system 315, a development application server 320, a development content replication server 325, an interface development server 330, a data services server 335, and a media conversion system 340.

In one embodiment, the development web server 305 comprises a web server containing a copy of the production web server. In one embodiment, the development web server 305 is utilized for testing new computer code and the modifications made by the developers before the code and modifications are introduced into the production environment.

In one embodiment, the development database 310 comprises a database containing a copy of the content of the production database. In one embodiment, the development database 310 is utilized to test changes to the system before the changes are implemented in the production environment. The production database and development database 310 contains guest information (including name, address, city, state, and zip), data relating to movies, music and music videos (including running time, date to start and stop showing, and title), tracking information (including number of times a person visited each section of the user system interface), and transaction information.

In one embodiment, the hotel point-of-sale system 315 comprises a conventional or custom-made point-of-sale (POS) system, as is well known in the art. Generally, POS comprises a computer system to facilitate interaction with customers and can generally be considered a computerized replacement for a cash register. Generally, POS systems can include the ability to record and track customer orders, process credit and debit cards, connect to other systems in a network, and manage inventory. Generally, a POS terminal has a personal computer or other computing device, which is provided with application-specific programs and I/O devices for the particular environment in which it serves. A POS system for a hotel, for example, is likely to have all hotel room information stored in a database that can be queried for information in a number of ways. POS terminals are used in most industries that have a point of sale such as a service desk, including restaurants, lodging, entertainment, and the like.

In one embodiment, the development application server 320 comprises an application server. In one embodiment, the development application server 320 contains a copy of the production application server. The development application server 320 is utilized for testing new computer code and the modifications by the developers before the code and modifications are introduced in the productions environment.

In one embodiment, the development content replication server 325 comprises a computer server. The development content replication server 325 contains a copy of the production content replication server. The development content replication server 325 is utilized for testing the loading process of movies, music and other entertainment content on the user system before moving the content to the production environment. In one embodiment, the development content replication server 325 comprises an array of hard drives to store mpg, mp3 and other media files.

In one embodiment, the interface development server 330 comprises a computer server. The interface development system 330 is utilized to test and develop new user system user interface features before the computer code is placed on the production web server.

In one embodiment, the data services server 335 comprises a group of workstations, servers, and software utilized in operating the customer relations management server.

In one embodiment, the media conversion system 340 comprises a group of workstations and software utilized in the conversion of analog music to mp3 format, conversion of DVD content to MPEG4 format, and the conversion of any other media format to a digital format compatible with the display and audio systems of the user system.

### VI. Content Source System

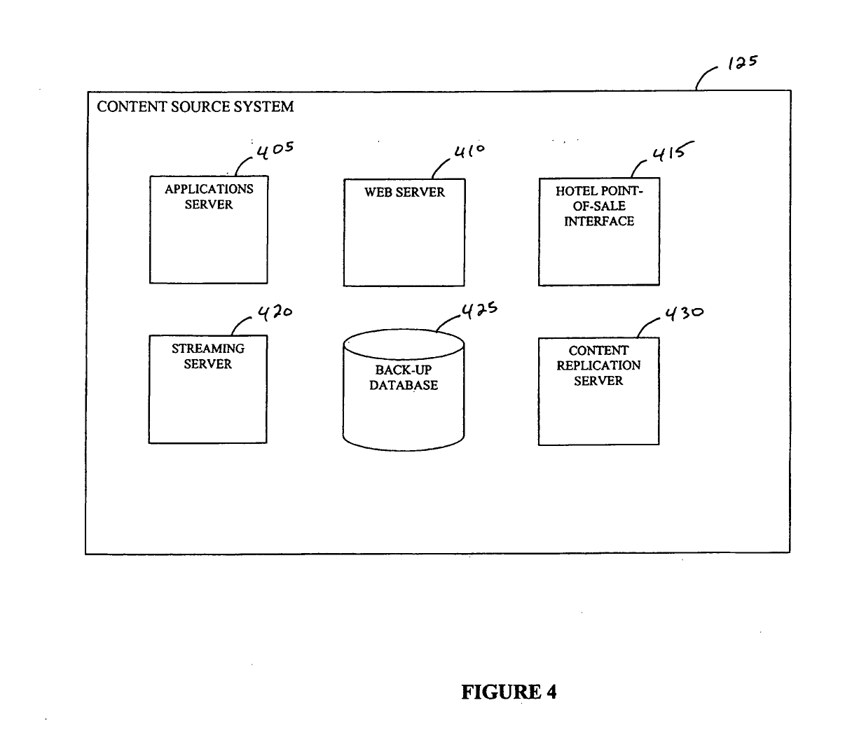

FIG. 4 illustrates a block diagram of the content source system 125, according to aspects of an embodiment of at least one of the inventions disclosed herein. As illustrated, in one embodiment, the content source system 125 can comprise an applications server 405, a web server 410, a hotel point-of-sale interface 415, a streaming server 420, a back-up database 425, and a content replication server 430.

In one embodiment, the applications server 405 comprises an application server, as is well known in the art. Generally, an application server is a server program in a distributed network that provides the business logic for an application program. The application server is frequently viewed as part of a three-tier application, consisting of a graphical user interface (GUI) server, an application (business logic) server, and a database and transaction server. Viewed in another way, using an application server divides the implementation of a system into three tiers. A first-tier is usually a front-end Web browser-based graphical user interface, operating on a client device such as a personal computer or workstation. A middle-tier is usually the business logic application or set of applications, possibly operating on a local area network or Intranet server. A third-tier is usually a back-end database and transaction server, usually operating on a mainframe or large server.

In one embodiment, the web server 410 comprises a computer server and/or computer program known as a “Web server” in the art. Generally, a Web server uses the client/server model and the Hypertext Transfer Protocol (HTTP) to serve the files that form Web pages to Web users (whose computers contain HTTP clients that forward the user's requests). Generally, most computers on the Internet that contain a Web site utilize a Web server program. Examples of Web servers include Apache® and Microsoft's Internet Information Server® (IIS). Other Web servers include Novell's Web Server for users of Novell's NetWare operating system and IBM's family of Lotus Domino® servers. Often, Web servers are utilized as part of a larger package of Internet and Intranet-related programs for serving e-mail, downloading requests for File Transfer Protocol (FTP) files, and building and publishing Web pages. Considerations in choosing an appropriate Web server for various embodiments include how effectively the Web server operates with the operating system and other servers, the Web server's ability to handle server-side programming, security characteristics, and publishing, search engine, and site building tools included with the Web server.

In one embodiment, the hotel point-of-sale interface 415 comprises a computer system that enables the content delivery system to communicate with a hotel's point-of-sale system. In one embodiment, the hotel point-of-sale system 415 enables the content delivery system to access the functions and data of the hotel point-of-sale system and/or modify or store data on the hotel's point-of-sale system.

: In one embodiment, the streaming server 420 comprises a computer server configured to provide streaming video and audio over a computer network. In one embodiment, the streaming server 420 is a specialized computer server configured to more effectively provide streaming video or audio. In one embodiment, the streaming server 420 distributes local television channels and sports betting.

Generally, streaming video is a sequence of moving images that are sent in compressed form over the Internet or any network and displayed by a viewing device as the images arrive. Streaming media is streaming video with sound. With streaming video or streaming media, a Web user does not have to wait to download a large file before seeing the video or hearing the sound. Instead, the media is sent in a continuous stream and is played as it arrives. Generally, the user requires a player or viewer, which is a computer program that decompresses and sends video data to the display and audio data to speakers. A player can be either an integral part of a browser or downloaded from the software maker's Web site.

Examples of streaming video and streaming media technologies include RealSystem G2® from RealNetwork®, Microsoft Windows Media Technologies® (including Microsoft NetShow Services® and Theater Server®), and VDO®. Streaming media can be in various commercial or custom-made formats, such as, for example, in Microsoft's Advanced Streaming Format (ASF). Finally, streaming video is usually sent from prerecorded video files, but can be distributed as part of a live broadcast “feed.” In a live broadcast, the video signal is converted into a compressed digital signal and transmitted from a special Web server that is able to perform a multicast or send the same file to multiple users at the same time.

In one embodiment, the back-up database 425 comprises a computer database configured to maintained data that is also maintained on another computer database. The back-up database 425 advantageously enables the content delivery system to prevent data loss where there is a malfunction such as a network, system, or computer malfunction. In the case where data is not available from its original source, the content delivery system can obtain the data by accessing the back-up database 425.

; In one embodiment, the content replication server 430 comprises a content replication server, as is well known in the art. Generally, a content replication server performs the process of creating and managing duplicate versions of content or a database. An example of a commercial content replication server is the Microsoft® Content Replication Server.

### VII. Sample Infrastructure of Content Delivery System

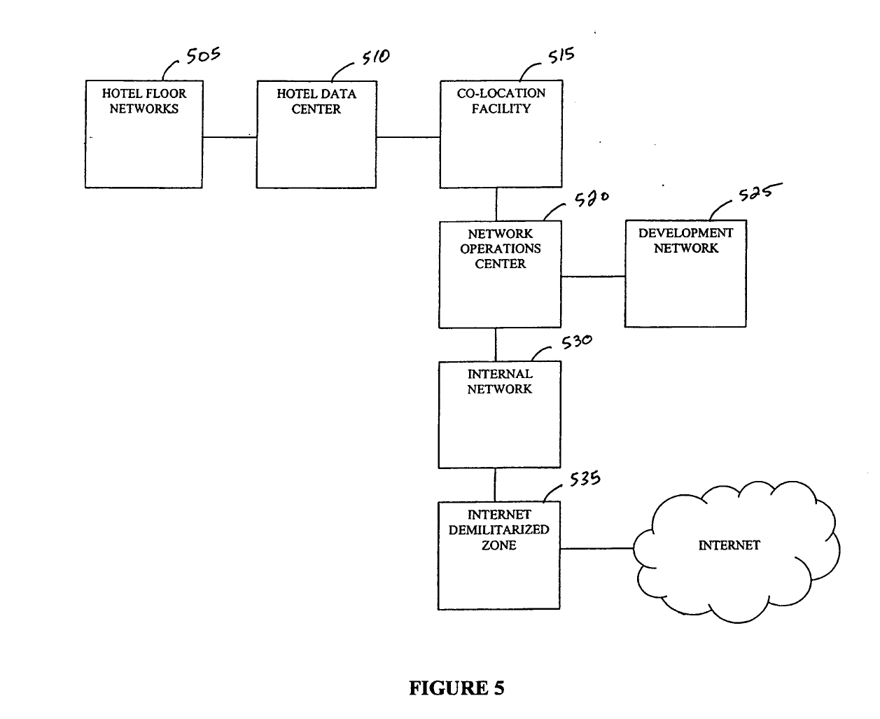

FIG. 5 illustrates a block diagram of a content delivery system, illustrating an exemplary but non-limiting embodiment of the infrastructure of the content delivery system. As illustrated, the content delivery system comprises a hotel floors network 505, a hotel data center 510, a co-location facility 515, a network operations center 520, a development network 525, an internal network 530, and an Internet demilitarized zone 535.

The hotel floors network 505 communicates with the hotel data center 510 through local network connectivity, such as through the central content distribution system 115. The hotel data center 510 communicates with the co-location facility 515 through firewalls, as is well known in the art, and preferably using a T-3 connection. Generally, a T-3 connection is a leased-line connection capable of carrying data at 44,736,000 bits-per-second. In some implementations, another type of connection, such as a T-1 connection, can be used. Generally, a T-1 connection is a leased-line connection capable of carrying data at 1,544,000 bits-per-second. In one embodiment, the communication between the hotel data center 510 and the co-location facility 515 is supported by a backup connection, advantageously enabling the hotel data center 510 and the co-location facility 515 to communicate even if the main T-3 connection is disrupted or is not available for use.

In one embodiment, the co-location facility 515 communicates with the network operations center 520 through firewalls, as is well known in the art, and utilizing a T-3 connection. The network operations center 520 communicates with the development network 525 through local network connectivity, such as through a local area network (LAN). The network operations center 520 communicates with the internal network 530 through local network connectivity, such as through a local area network (LAN). In one embodiment, the internal network 530 communicates with the Internet demilitarized zone 535 through a firewall, as is well known in the art. In one embodiment, the Internet demilitarized zone 540 communicates with the Internet through an Internet router, as is well known in the art.

A. Hotel Floor Networks

In one embodiment, the hotel floor networks 505 comprises a switch for each hotel floor, a hotel floor content replication NAS, and the user systems 105.

B. Hotel Data Center

In one embodiment, the hotel data center 510 comprises a streaming media server for local channels, a content replication NAS, a data center switch, a backup database/hotel point-of-sale system, a web server, and an application server.

C. Co-Location Facility

In one embodiment, the co-location facility 515 comprises a co-location facility switch, a primary domain name server (DNS), a transaction database, a customer relationship management server, a hotel management reporting server, a secondary DNS, a content replication staging network attached storage (NAS), an email server for hotel paging services, and a backup corporate file server. The components of the co-location facility 515 communicate with the hotel data center 510 and the network operations center 520 through the co-location facility switch and the firewalls. The customer relationship management server comprises a server utilized for the correlation of database data. The database data comprises hotel guest interest profiles, hotel guest buying profiles, and other relational data that allows a hotel to better understand and cater to the hotel's guests. The content replication staging NAS comprises a server utilized in the process of moving the movies, music, and music videos from the development replication staging NAS to the user system.

D. Network Operations Center

In one embodiment, the network operations center 520 comprises a firewall and a user system management server. The network operations center 520 utilizes the firewall to communicate with the co-location facility 515.

E. Development Network

In one embodiment, the development network 525 comprises a development content replication server, a development Web server, a development application server, and a development database/hotel point-of-sale (POS).

F. Internal Network

In one embodiment, the internal network 530 comprises a corporate network attached storage (NAS), and a firewall. The internal network 530 utilizes the firewall to communicate with the network operations center 520 and the Internet demilitarized zone 535, as is well known in the art.

G. Internet Demilitarized Zone

In one embodiment, the Internet demilitarized zone 535 comprises a firewall, and an Internet router. The Internet demilitarized zone 535 enables the internal network 530, and thus the content delivery system, to communicate with the Internet while advantageously maintaining data and access security.

### VIII. Processes

Various processes enabled or performed by the content delivery system are described below. It is to be understood that these processes are meant to illustrate, not limit, at least one of the inventions disclosed herein, and other processes and variations thereof are enabled by the content delivery system.

A. Guest Check-In

A guest check-in occurs when a potential client of the hotel decides to stay at the hotel. The hotel check-in clerks uses the POS terminal to access a guest data input screen. The clerk enters guest information into the database. The guest information can include for example, but without limitation, first name, middle name, last name, first line of address, second line of address, city, state, zip code, country, province, RFID number, and Personal Identification Number (PIN). The clerk can also associate a RFID (Radio Frequency Identifier Device) serial number with the newly created guest account and can prompt the guest for a 6 digit Personal Identification Number (PIN). For example, the guest can choose their own PIN, or have a PIN assigned to them by the clerk. The PIN can be used by the guest to access restricted content noted above, such as the gambling features, adult entertainment, or other restricted content. The guest is given the RFID. The clerk provides the guest with: a brief explanation regarding using the RFID, and the clerk completes the hotel's check-in process.

B. Loin

Login occurs when a guest decides to use the issued RFID in the hotel room. The guest enters the room and presents the RFID to the user system. The user system scans the RFID serial number from the RFID card. The user system 105 then request RFID verification from the security database. The security database performs a verification for that guest and the room. If verified, the user system presents introductory information and initiates a demonstration of the usage of the user system. The guest is then granted access to the user system 105.

C. Movie Purchase

When a guest decides to purchase a movie for viewing, the following steps can be performed. For example, but without limitation, the guest can enter the movie sub menu of the Entertainment category (FIG. 6) of the user interface 205 (FIG. 2) of the user system 105. The guest can browse the movie selections using the user interface. If the guest decides to not purchase a movie, the user interface allows the guest to exit the process. If the guest decides to purchase a movie, the user is presented with a “buy” option whereby the guest can purchase the movie by pressing a “buy” button provided on user input device, or another button configured to emit a selection signal to the control system 210. The process can utilize various confirmation messages to inform the guest that a binding transaction is about to occur.

The purchase transaction can be completed in any manner. In some embodiments, the user system 105 is configured to issue a debit request to the Presentation Management System 120. For example, but without limitation, in the illustrated embodiment, the user system 105 can be configured to issue a debit request to the Hotel POS System 315, the debit request including at least an amount of money charged for the access requested. In some embodiments, the debit request can also be media specific. For example, the debit request can include data indicative of the category of the media (music, music video, movie, etc), the length of the media, and/or the title. Additionally, the debit request can be configured to include user data indicative of the specific user system issuing the debit request. In the example of a hotel system, the user data can indicate from which hotel room the debit request was issued.

In this arrangement, the Hotel POS System 315 can be configured to receive and process debit requests from user systems 105. As such, the Hotel POS System 315 preferably is configured to read user data from the debit request, and correlate the debit request to a user, guest, or room number of the hotel. The debit request can then be processed by adding a charge to the hotel bill associated with that room number. The charges can be collected for payment at check out, or any other time. For example, In some embodiments, the Hotel POS System 315 can be configured to automatically charge a credit card of the user or guest as purchases accrue to the account associated with the guest or room. Alternatively, the Presentation Management System 120 can be configured to create and manage billing accounts for each user separate from the Hotel POS System 315. For example, but without limitation, the user system 105 can be configured to allow a user to create an account and submit billing information for all charges associated with use of the user system 105. For example, the user system 105 can be configured to allow a user to submit credit card information in a manner commonly used for Internet based transactions.

The Hotel POS System 315 can also be configured to, when the debit request is successfully completed, issue an access authorization to the requesting user system 105. The access authorization can be in any form. For example, but without limitation, the access authorization can be in the form of data indicating the amount of time of access is to be granted for a particular media file, a plurality of media files, one or a plurality of groups of media files, or all media files. In this embodiment, the media viewer used to access the media on the user system 105 can be configured to access only the media files identified in the access authorization, for the amount time indicated in the access authorization. In this embodiment, the access authorization can be stored in any memory device in the user system 105. Alternatively, a sentinel software module can be included in the user system 105 that is configured to prevent any user access to a media file unless a suitable access authorization has been issued to the user system 105.

In some embodiments, an access database can be included in the Presentation Management System 120. In this arrangement, the access database can include a database of users or guest rooms, and the types of access each user can purchase. For example, in one non-limiting embodiment, the access data base can be a 2-dimensional table with users or guest rooms on one axis and the types of access on the other. For example, each user or guest can be assigned one row of the table and each type of access can be assigned to each column.

In this arrangement, each column can represent a media file available for access. Each cell of the table can include a flag indicating weather or not the corresponding user has access to the corresponding media file. For example, but without limitation, the flag can be a 1 or a 0, or a “yes” or “no”, or “on” or “off”. Thus, when a user or guest purchases access to a media file, the Hotel POS System 315 or any other portion of the system that tracks transactions, can be configured to update the access database to change the flag to indicate that the user that paid for access, in fact, has access authorization.

Optionally, the Presentation Management System 120 can be configured to revoke authorization after the user's access time has expired. For example, the Presentation Management System 120 can be configured to update the access database to change the flag to indicate that the user no longer has access, after the time associated with the debit request has expired.

In embodiments where the Presentation Management System 120 maintains an access database such as that described above, the user system 105 preferably is configured to periodically check the access database for proper authorization, at least when a media viewer of the user system 105 is being used to access media content on the user system 105. For example, a separate access module can be included with the user system 105. Such an access module can be configured to track what media content is currently being viewed on the user system 105 and to periodically query the access database to determine if access for the media being accessed has been authorized for the user or the room number. The access module can be configured to query the access database ant any interval, such as, for example, but without limitation, 1 second, 2 seconds, 10 seconds, 1 minute, 2 minutes, 10 minutes, 15 minutes, etc. Using shorter intervals provides more accuracy in granting or revoking access, but also increases network traffic. In some embodiments, the access module can be incorporated into the media viewers included in the user system 105. In some embodiments, the access database can be stored on the user system 105.

In other embodiments, the Hotel POS System 315 can be configured to issue a command to the requesting user system 105 that unlocks the specific media corresponding to the debit request. For example, the user system 105 can be configured to lock or unlock media files for read access, in response to commands from the Hotel POS System 315 or any other part of the Presentation Management System 120. In this arrangement, the Hotel POS System 315 or another corresponding part of the Presentation Management System 120 can be configured to grant access to specific media files for limited periods of time, issuing an access command to the corresponding user system 105 at the beginning of the authorized access period and issuing a revocation command at the end of the authorized access time period.

Any of the above described embodiments can be configured to give the user access to content such as a movie in a variety of ways. For example, the system can be configured to allow the movie to be played only once, with or without the ability to pause the movie. Optionally, the system can be configured to allow the movie to be viewed for a predetermined amount of time, and allowing the user to pause and rewind, and/or or view portions or the entire movie plural times.

Moreover, the system can be configured to give the user access to any content in a variety of ways. For example, the system can be configured to allow the content to be played only once, with or without the ability to pause the content. Optionally, the system can be configured to allow the content to be played for a predetermined amount of time, and allowing the user to pause and rewind, and/or or play portions or the entire content plural times. This configuration can be performed because the content is maintain locally with the user system, and therefore, various operations such as pause, rewind, and play can be performed on the content. All of the embodiments described above with reference to a movie purchase can be modified for use with the purchase of access to any of the media content on the user system 105. Thus, the music purchase description et forth below does not repeat the description of all the optional variations noted above, however, it is to be understood that the above noted alternatives apply to any of the possible content purchases described herein.

D. Music Purchase

When a guest decides to purchase a music, the following steps are performed. The guest enters the music section of the user interface of the user system. The guest can browse the music selections using the user interface. If the guest decides to not purchase a music selection, the user interface allows the guest to exit the process. If the guest decides to purchase a music selection, the user is presented with a “buy” option whereby the guest can purchase the music selection by pressing “buy” on a remote interface device. The process can utilize various confirmation messages to inform the guest that a binding transaction is about to occur. Once the guest confirms the music purchase, the purchase transaction is recorded in the database and the music is then the user can play the music on the user system 105.

E. Hotel Management Reporting

The hotel management reporting process allows the management of hotels to view reports pertaining to their hotel. Generally, the process starts when a manager, using a computing device, logs into the hotel reporting system. The hotel reporting system presents various reporting options to the manager. The manager selects a reporting option. The hotel reporting system utilizes the appropriate database, compiles the appropriate date, and prepares the requested report. The hotel reporting system generates the report and presents the report to the manager through the manager's computing device.

F. Guest Survey

It can be advantageous to survey the guests in order to improve targeted marketing to those guests. A guest survey can take place at various occasions, such as during check-in, during the use of a user system, or at another opportunity. Data fields for the survey can include a variety of information. For example, the survey fields can include age, race, income range, number of children, number of male children, number of female children, number of vehicles in household, and occupation. The survey fields can also relate to the guest's gambling preferences and history, and the data fields can include maximum bet amount, minimum bet amount, average bet, and comps (i.e. complimentary items) earned. The data fields can also relate to the movies viewed, casino games played, music purchased, favorite music genres, and the like.

Although the present invention has been described in terms of a certain preferred embodiment, other embodiments apparent to those of ordinary skill in the art also are within the scope of this invention. Thus, various changes and modifications may be made without departing from the spirit and scope of the invention. The scope of the present invention is intended to be defined only by the claims that follow.

What is claimed is:

1. A method for distributing media content across a communications network comprising at least one server and at least one client device, the client device having at least one storage device, the method comprising:
sending a plurality of media files from the server to the client device;
sending a command from the server to the client device, the command directing the client device to store the plurality of media files in the storage device;
allowing a user to browse through descriptions of the media files in the storage device;
preventing the user from accessing the media files in the storage device;
communicating with the server to authorize the user to access at least one media file in the storage device; and
allowing the user to access the at least one media file if the user is authorized to access the media file.

2. The method according to claim 1, where the step of sending a plurality of media files comprises sending a plurality of the video files from the server to the client device, each of the video files having a normal playtime of at least 30 minutes.

3. The method according to claim 1, wherein the step of sending a command from the server comprises sending a command to the client device causing the client device to store the plurality of files in the storage device without the need for any user inputs to the client device.

4. The method according to claim 3, wherein user inputs includes commands input through an infrared input device directly to the client device or commands input to the client device through a control system over the network.

5. The method according to claim 1 additionally comprising requesting payment from the user for access to at least one of the media files stored in the storage device.

6. The method according to claim 1 additionally comprising deleting at least one of the media files stored in the storage device without the need for any user commands to be input to the client device.

7. The method according to claim 6 additionally comprising adding at least one media file to the storage device without the need for any user commands to be input to the client device.

8. A method for selling media content to users of a client device having a storage device and connectable to a network, the method comprising:
storing a plurality of media files in the storage device of the client device;
allowing the user to browse descriptions of the media files stored in the storage device;
preventing the user from accessing the entirety of the media files; and
allowing a user to authorize payment for access to at least one of the media files.

9. The method according to claim 8, wherein the step of storing a plurality of media files comprises storing a plurality of video files, each video file being more than 30 minutes long when played at normal speed.

10. The method according to claim 8 additionally comprising adding different media files to the storage device without the need for any user inputs to the client device.

11. The method according to claim 8 wherein storing a plurality of media files in the storage device comprises saving the plurality of media files and a secured library defined in the storage device.

12. The method according to claim 11, wherein the plurality of media files are encrypted.

13. A method of tracking fees to guests of a hotel having at least one client device in each of a plurality of guestrooms in a hotel, the client device comprising a video display and computer connected to a server, the method comprising:
storing a plurality of full-length major motion pictures on a storage device of the client device;
allowing a user to browse descriptions of the full-length major motion pictures;
preventing the user from fully accessing the full-length major motion pictures;
requesting confirmation for authorization for the user to access at least one of the full-length major motion pictures;
allowing the user to fully access the at least one full-length major motion picture only if authorization is confirmed.

14. The method according to claim 13 additionally comprising sending fee information to an accounting server of the hotel indicating that the user should be charged a fee for access to the at least one full-length major motion picture.

15. A communications network for distributing media content comprising:
at least one server; and
at least one client device having a storage device therein, the client device configured to receive media files from the server and to store the media files from the server on the storage device without the need for any user inputs to the client device, the client device being configured to allow a user of the client device to access the media files only if the user is authorized to access the media files.

16. The network according to claim 15, wherein the server is configured to add different media files to the storage device of the client device without the need for any user inputs to the client device.

17. The network according to claim 16, wherein the server is configured to delete media files from the storage device of the client device without the need for any user inputs to the client device.

18. A communications network for distributing media content comprising:
at least one server configured to distribute media content over the network;
at least one client device communicating with the server over the network; and
means for storing media content from the server on a storage device of the client device without the need for any user inputs to the client device, means for deleting and adding media content to the storage device of the client device from the server, without the need for any user inputs to client device, and means for selectively allowing a user to access the media content based on a payment protocol.

19. A workstation comprising:
a video display;
a processor;
memory; and
computer readable media stored in the memory and configured to allow the workstation to accept a plurality of media files from a server over a network, to store the plurality of media files in the memory without the need for any user inputs to the workstation, and to selectively allow a user to access the media files if the user has authorization.
